(19) United States
(12) Patent Application Publication
(10) Pub. No.: US 2006/0134364 A1
(43) Pub. Date: Jun. 22, 2006

(54) Clear, peelable plastic labels

(76) Inventors: Leo M. Landoll, Hockessin, DE (US); Benjamin Tuttle, Schwenksville, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/304,357

(22) Filed: Dec. 15, 2005

Related U.S. Application Data
(60) Provisional application No. 60/636,756, filed on Dec. 16, 2004.

(51) Int. Cl. B32B 33/00

(52) U.S. Cl. 428/40.1

(57) ABSTRACT

A clear plastic label for attachment to a product package, such as a glass bottle, through a tacky adhesive component. The clear plastic label includes at least an outer plastic substrate and an inner substrate secured together though a weak interlayer bond. The inner substrate has a lower surface secured to the product package through the tacky adhesive and has a peel strength to the tacky adhesive greater than the peel strength of the weak interlayer bond. Thus, when a person applies a peel force to the clear plastic label, the outer plastic substrate is peeled from the product by separating from the inner substrate at the weak interlayer bond, thereby leaving the inner substrate overlying the tacky adhesive to eliminate the tacky feel of the adhesive and at least partially mask any odor of the adhesive.

### RELATED APPLICATIONS

This application claims the benefit of earlier-filed provisional application Serial No. 60/636,756 filed on Dec. 16, 2004.

### FIELD OF INVENTION

This invention relates generally to plastic labels for product packages, and more specifically to clear plastic labels employed on product packages, preferably transparent product packages such as transparent containers or bottles for beverages, such as soda, beer and ale. More specifically, this invention relates to clear plastic labels that preferably are applied to transparent glass bottles, e.g., beer, ale or soda bottles, to provide a desired aesthetic appearance to the labeled product.

### BACKGROUND OF THE INVENTION

Clear pressure-sensitive labels may be applied to product packages, such as glass bottles, by a variety of systems, including a continuous system employing radiation curable adhesive, as 15 disclosed in Hill, IV, et al., U.S. Pat. No. 6,517,661 (the “Hill '661 patent”) and systems employing die-cut labels including a pressure-sensitive adhesive covered by a removable release liner on one surface thereof, as disclosed in U.S. Pat. Nos. 5,705,024; 5,584,955 and WO 99/55517. In all cases, the systems work with adhesives that are, or become tacky to provide their adhesive function, e.g., pressure-sensitive adhesives and cold seal adhesives, and in many cases such adhesives possess an unpleasant odor.

When the pressure-sensitive label is in place on a container, it effectively covers the adhesive, thereby preventing a person holding the container from coming into contact with the tacky adhesive, and actually transferring the tack and, in some cases, an unpleasant odor to a person's hand(s).

However, it is a common practice for individuals drinking beer or other beverages from a glass bottle or other container to actually pick at, and peel the label from the surface of the bottle. When this occurs, the container becomes aesthetically impaired, i.e., the surface of the bottle becomes objectionably sticky or tacky, and the odor emanating from the pressure-sensitive adhesive may transfer to the consumer's skin, further causing irritation to the skin and/or imparting an unpleasant taste to food being handled by the consumer.

With paper and opaque plastic film labels it is known to provide for z-axis split, such that only an outer layer of the label is removed, with in inner layer of the label being retained on the container to continue to mask the adhesive. However, to applicant's knowledge there has been no effort made, or any suggestion how to design a clear plastic label that ensures that the pressure-sensitive adhesive will be covered and protected, even if a user attempts to peel the label from the bottle surface. Moreover, it is desirable to design a clear label such that a removable outer portion, can, if desired, provide a secondary function or benefit, such as being a coupon or collectable item. It is to such clear plastic labels that the present invention is directed.

All references cited or identified herein are incorporated herein by reference in their entireties.

### SUMMARY OF THE INVENTION

The above and other objects of this invention are achieved in a clear plastic label that includes at least an outer plastic substrate and an inner substrate secured together through a weak interlayer bond, with the inner substrate having a lower surface designed to be secured to a product package, e.g., a glass bottle, through a tacky, pressure-sensitive adhesive. The clear plastic label is designed such that it has a peel strength to the tacky adhesive greater than the peel strength of the weak interlayer bond, whereby, when a person holding the bottle attempts to peel the clear plastic label from the bottle, the outer plastic substrate peels away from the inner substrate at the weak interlayer bond; leaving the inner substrate in a position adhered to, and overlying the tacky adhesive to eliminate the tacky feel associated with the adhesive and also to at least partially mask any odor emitted by the adhesive. Moreover, if desired, the outer plastic substrate can have separate utility, such as, but not limited to, a coupon or collectable item, in which case the outer plastic substrate includes desired printed indicia thereon.

In accordance with the broadest aspect of this invention, the weak interlayer bond can be provided in more than one way. For example, the weak interlayer bond can be provided by a clear laminating adhesive secured to the lower surface of the outer plastic substrate and the upper surface of the inner substrate by any well know technique, such as by extrusion coating. Alternatively, and more preferred, the weak interlayer bond is provided by a bonded interface between the lower surface of the outer plastic substrate and the upper, contiguous surface of the inner substrate.

In the preferred embodiments of this invention, the outer plastic substrate essentially is any conventional, prior art clear plastic label, such as clear, cut and stack labels cut from clear plastic films of the type sold under the designations TCL 139 and TCL 190 by Applied Extrusion Technologies, Inc., located in New Castle, Del. In addition, the clear plastic labels can be of the type employing a pressure-sensitive adhesive covered by a release liner, such as are identified in the U.S. patents and international publication referenced earlier in this application. The labels usable in this invention can either be a monolayer or multilayer structure, and, in accordance with this invention are clear, and most preferably multilayer structures.

The inner substrate, in accordance with one embodiment of the invention, is a biaxially oriented, multilayer structure including an upper, polypropylene core layer and a lower polyethylene skin layer; preferably a low density polyethylene skin layer. The upper surface of the core layer is secured to the lower surface of the outer plastic substrate by a laminating adhesive, which provides the weak interlayer bond, or component, in the label. The lower surface of the polyethylene skin layer has excellent compatibility to a radiation curable adhesive of the type disclosed in the Hill '661 patent, and in that environment tenaciously bonds to the radiation curable adhesive.

The layer of radiation curable adhesive preferably is a UV curable adhesive, and is applied to the label structure in the manner described and claimed in the Hill '661 patent, the subject matter of which already has been incorporated by reference herein.

In a second, and more preferred embodiment of this invention, the weak interlayer bond is provided by the bonded interface between a lower surface of the outer label substrate and an upper contiguous surface of an inner substrate. In this embodiment the inner substrate is generally quite weak, and substantially thinner than the multilayer inner substrate employed in the above-described, first embodiment of this invention.

In this second, more preferred embodiment of the invention, the inner substrate has an upper surface, which provides a weak bond to the lower surface of the outer substrate, and a lower surface, which has a strong bond to the pressure-sensitive adhesive employed to adhere the label to the product package, e.g., a glass bottle or container. In this embodiment, when an individual attempts to peel the label from the product package, the upper plastic substrate separates from the inner substrate at the bonded interface between those substrates, thereby leaving the inner substrate in a position attached to, overlying and covering the pressure-sensitive adhesive. Moreover, in this embodiment the inner substrate is quite thin and weak, preferably having a thickness less than 0.15 mils, and more preferably in the range of 0.1 to about 0.12 mils. Thus, this inner substrate, which is tenaciously bonded to the bottle through the pressure-sensitive adhesive, cannot be easily grasped and also does not have enough strength or integrity to be peeled away as a single layer from the package surface to expose the adhesive.

### BRIEF DESCRIPTION OF THE DRAWINGS

The invention may be more fully understood with reference to the accompanying drawings wherein:

FIG. 1 is an enlarged sectional view of a first embodiment of a label in accordance with this invention, attached to a wall of a container, such as a glass bottle; and

FIG. 2 is an enlarged sectional view of a second embodiment of a label in accordance with this invention, attached to a wall of a container, such as a glass bottle.

### DETAILED DESCRIPTION OF THE INVENTION

The above and other objects of this invention are achieved in a multilayer clear plastic label including at least an outer plastic substrate, an inner substrate secured to the outer substrate through a weak interlayer bond, with the inner substrate having a lower surface secured to a product package through a tacky pressure-sensitive adhesive and having a peel strength to the tacky adhesive greater than the peel strength of the weak interlayer bond. Because of this construction, when a person holding the product package attempts to peel the plastic label therefrom, the outer plastic substrate is peeled away from the inner substrate at the weak interlayer bond, thereby leaving the inner substrate in a position overlying the tacky adhesive to eliminate the tacky feel of the adhesive and at least partially mask any odor of the adhesive.

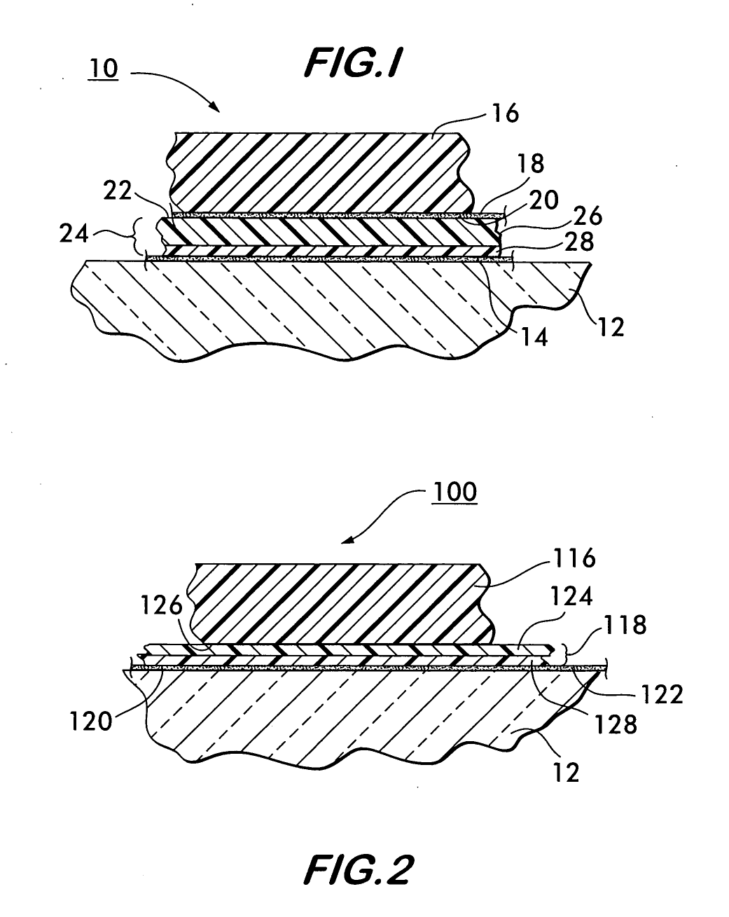

As illustrated in FIG. 1, the clear plastic label 10 is adhered to a product package, such as a transparent beverage (e.g., beer, ale, etc.) bottle 12 through a pressure-sensitive adhesive 14.

Since, the preferred use of the labels of this invention is with transparent plastic bottles or containers, the invention will be described in connection with such bottles or containers. However, it should be understood that reference to a “product package” or references of similar impact are not limited to glass bottles or containers.

The pressure-sensitive adhesives employed in this invention can be radiation curable adhesives, such as UV curable adhesives of the type that become tacky upon being at least partially cured with radiation, as disclosed in the aforementioned Hill '661 patent.

Suffice it to state that the clear multilayer labels of this invention can be retained in a stacked relationship in a conventional dispensing magazine, and the lowermost label in the stack can be sequentially removed with the simultaneous application of a radiation curable adhesive to the lower surface, and thereafter, each of the labels can be directed through a radiation cure station, such as a UV cure station to render the adhesive sufficiently tacky to be adhered to the outer surface of bottles directed through the labeling system on a rotating turret. Alternatively, the labels of this invention can be die-cut labels of the type employing a clear pressure-sensitive adhesive covered with a conventional silicone release liner.

In any event, the specific pressure-sensitive adhesive that is employed does not constitute a limitation on the broadest aspects of this invention. However, as will be explained in further detail hereinafter, it is important that the adhesive adhere the label to the product package with greater tenacity and peel strength than the peel strength of the weak interlayer bond provided in the label 10.

Still referring to FIG. 1, the multilayer label 10 includes an outer plastic substrate 16, which can be any conventional clear plastic label, such as a multilayer, clear plastic label formed from a clear plastic film sold by Applied Extrusion Technologies, Inc. of New Castle, Del. , under the designation TCL 139 or TCL 190. This clear plastic label is a multilayer. structure having an internal core and opposed, relatively thin skin layers. The core preferably is formed of polypropylene (as defined hereinafter), with an outer skin layer being formed of a propylene/ethylene copolymer including approximately 2% ethylene in it, and the opposed skin layer can be polypropylene, preferably with a slip agent in it, and also which is oxidatively treated, e.g., by corona or flame treated, to render the surface of that layer printable. This multilayer film typically has a thickness of about 2.2 mils (220 gauge), with the thickness of the core layer being 2.0 mils; the thickness of the polypropylene skin layer being 0.1 mils and the thickness of the opposed skin layer being 0.1 mils. Preferably, the plastic substrate 16 employed in this invention has a thickness greater than 1.5 mils; more preferably greater than 2 mils and as noted above, in the most preferred embodiment about 2.2 mils.

This outer plastic substrate 16 has been conventionally used by itself as a clear label in the UV labeling system described in the Hill '661 patent. However, it should be understood that a variety of different clear plastic substrates can be employed as the outer plastic substrate 16 in accordance with this invention.

Reference in this application to “polypropylene” unless indicated otherwise, means a crystalline propylene homopolymer or a copolymer of propylene with another α-monoolefin having from 2 to 5 carbon atoms in an amount insufficient to have a significant effect on the crystallinity of the polypropylene. Typically, this is ethylene in an amount of less than 2%, and more preferably less than 1% by weight of the copolymer.

Reference in this application to “α-monoolefin” unless indicated otherwise, means a linear unsaturated hydrocarbon monomer having one carbon-carbon double bond, which double bond is located at the end of the linear chain. The term is intended to include any such monomer having 6 carbon atoms or less, including ethylene and propylene.

Still referring to FIG. 1, the weak interlayer bond is provided by a thin, laminating adhesive 18, which can be either water based or solvent based; such laminating adhesives being well known to people skilled in the art. This laminating adhesive is bonded to lower surface 20 of the outer plastic substrate 16 and to the upper surface 22 of inner substrate 24. In an exemplary embodiment of this invention the clear laminating adhesive is Robond L-37 supplied by Rohm and Haas and is applied as a very thin layer, on the order of 0.1 mil, by a conventional coating operation. This laminating adhesive works well with an inner substrate 24 sold commercially by Applied Extrusion Technologies under the designation PEOS. This inner substrate is an extruded, multilayer, biaxially oriented plastic film including a polypropylene core 26 and a lower, relatively thin low-density polyethylene skin layer 28.

The core 26 of the inner substrate 24, in the exemplary embodiment, actually is a propylene/ethylene mini random copolymer, with the ethylene content being approximately 0.1%. The low-density polyethylene in the skin layer 28, which has a density of 0.92 g/cc or lower, creates a very effective bond with an acrylic, UV curable adhesive 24 of the type disclosed in the Hill '661 patent. A representative low-density polyethylene usable in the skin layer 28 of the PEOS inner substrate 24 is M2512, supplied by Equistar. Equistar is headquartered in Houston, TX.

It should be understood that the polymer(s) employed in the skin layer 28 will be selected to provide an effective bond with the particular pressure-sensitive adhesive employed to adhere the label to a product package with a peel strength greater than the peel strength of the laminating adhesive 18. In some cases, the inner substrate 24 may be formed as a single layer, with one polymer, or polymer system.

In a representative embodiment of this invention the inner substrate 24 has a thickness of about 0.50 mils, which is a relatively thick structure. In particular, in the specifically disclosed embodiment the core 26 has a thickness of about 0.40 mils and the skin layer 28 has a thickness of about 0.10 mils.

When a person drinking a beverage from a bottle 12 including the clear plastic label 10 of this invention applies a peeling force to the label, the outer plastic substrate 16 separates from the inner substrate 24, either through the laminating adhesive 18, or at one or both of the interfaces of the laminating adhesive with the lower surface 20 of the outer plastic substrate or the upper surface 22 of the inner substrate. Thus, when the outer plastic substrate 16 separates from the bottle 12, the inner substrate 24 remains over the pressure-sensitive adhesive to protect the user from the undesired tackiness of the adhesive and any undesirable odor generated, or emitted, by the adhesive.

However, the plastic label 10 does have a deficiency, in that the inner substrate 24 remaining on the bottle is a biaxially oriented plastic substrate that is relatively thick and has sufficient strength and integrity to permit a person holding the bottle to peel the inner substrate off the bottle, thereby exposing the pressure-sensitive. Thus, even after separation of the outer substrate 16 from the inner substrate 24 it is possible for a user to actually expose the tacky adhesive both to the feel and smell of the user by peeling away the inner substrate, which is undesirable.

A second and more preferred clear plastic label is illustrated at 100 in FIG. 2. The label 100, like the label 10, includes an outer plastic substrate 116 and an inner substrate 118. The outer plastic substrate 116 can be the same as the outer plastic substrate 16 employed in the label 10. Therefore, suffice it to state that, as in the first embodiment of this invention, the outer plastic substrate 116 can be any conventional clear plastic substrate, as discussed in detail in connection with the label 10. No further discussion of the outer plastic substrate 116 is considered to be necessary herein.

The inner substrate has a lower surface 120 that is attached to bottle 12 through a pressure-sensitive adhesive 122, which can be the same as the pressure-sensitive adhesive 14 employed with the label 10. A discussion of these adhesives will not be repeated herein, for purposes of brevity.

In the label 100 a separate laminating adhesive is not employed. Rather, the inner substrate 118 includes an upper plastic layer 124 that provides a weak bond to the lower surface 126 of the outer plastic substrate 116, and a lower layer 128 made of a plastic material that is compatible with the pressure-sensitive adhesive 122 to provide a tenacious bond to the bottle 12. This latter bond has substantially greater peel strength than the peel strength between the outer plastic substrate 116 and the upper plastic layer 124 of the inner substrate 118.

When the outer plastic substrate 116 is a multilayer substrate, such as the clear plastic 30 label substrate sold under the designation TCL 139 or TCL 190 by Applied Extrusion Technologies, Inc., the upper plastic layer 124 of the inner substrate 118 can be provided by a water-based polyurethane film layer applied as an aqueous coating to the lower surface of the polypropylene skin layer of the outer plastic substrate 116 to provide a weak bond to said polypropylene skin layer. The lower layer 128 of the inner substrate 118 can be a coating of an acrylic polymer applied over the polyurethane layer, which is compatible with, and provides a tenacious bond to an acrylic UV curable adhesive of the type described in the Hill '661 patent. In the preferred embodiment of this invention, the polyurethane film layer is not cross-linked and, as noted above, provides a weak bond to the outer plastic substrate 116.

In fact, in the preferred embodiment of this invention, the bond between the outer plastic substrate 116 and the upper plastic polyurethane layer 124 of the inner substrate 118 has a peel strength of less than 600 g/in.; more preferably less than 300 g/in. and most preferably less than 100 g/in. In distinction, the bond created between the lower layer 128 of the inner substrate 118 and the pressure-sensitive adhesive 122 on the bottle 12 preferably has peel strength in excess of 600 g/in.

The inner substrate 118 is substantially thinner than the inner substrate 24 employed in the label 10, and preferably is less than 0.15 mils; more preferably less than 0.12 mils, and more preferably in the range of 0.1 to about 0.12 mils.

The inner substrate 118 is provided in the label 100 by first applying the upper urethane layer 124 to the lower surface 126 of the outer plastic substrate 116 by a conventional gravure coating roll. Thereafter, the urethane layer 124 is dried and over coated with an acrylic polymer, which provides the lower layer 128 of the inner substrate 118. This lower acrylic layer 128 provides better adherence than the urethane to an acrylic UV curable adhesive of the type disclosed in the Hill '661 patent, which is one of the preferred types of adhesives that can be employed as the adhesive layer 122 in the present invention.

It should be understood that the specific construction of the inner substrate 118 will be dictated by both the composition of the outer plastic substrate 116 and the composition of the pressures-sensitive adhesive 122 employed to adhere the clear plastic label 100 to a product package, such as a transparent bottle or container 12.

In an exemplary embodiment, as described above, the inner substrate 118 includes an upper polyurethane layer 124 and a lower acrylic layer 128 in connection with an outer, clear plastic substrate 116, wherein the lower surface 126 of the outer clear plastic substrate is a lower surface of a polypropylene skin layer and the adhesive 122 employed to adhere the label 100 to bottle 12 is a UV curable, acrylic binder.

A variety of different coatings may be usable in the inner substrate of this invention, as can easily be determined by individuals skilled in the art. For example, in an alternative construction, the lower layer 128 of the inner substrate 118 may employ polyvinylidene chloride (PVDC) copolymer latexes. Such latexes may provide the desired barrier properties over the adhesive. Moreover, since these latexes include small amounts of acrylic comonomer in them, UV adhesives would be expected to provide a tenacious bond between the label and container. An entire product line of these PVDC copolymer latexes is available from Rohm and Haas under the Serfene trademark. The key is to control adhesion to the clear outer plastic substrate such that the peel strength to the outer plastic substrate is less than the peel strength of the polyvinylidene chloride copolymer latexes to the adhesive employed to adhere the label to a container, e.g., a bottle. The peel strength of the inner substrate 118 to the outer plastic substrate 116 may be adjusted with a polyurethane primer, or by varying the crystallinity of the PVDC. These PVDC coatings would all be unoriented, and therefore lack the needed integrity to be grasped and peeled from the container as an uninterrupted layer. Hence these PVDC coating would function much like the current preferred embodiment disclosed in FIG. 2.

It also may be possible to employ a somewhat thicker, unoriented, low strength coating by extrusion coating onto the clear outer plastic substrate a soft, non-tacky polymer with limited adhesion. There are a wide variety of polymers that may be suitable for this purpose, but low density polyethylene (LDPE), ethylene vinyl acetate (EVA), ethylene methyl acrylate (EMA) and ethylene-acrylic acid (EAA) are all well known extrusion coating polymers that may be usable in this invention. All can be extrusion coated onto the polypropylene layer of the clear outer plastic substrate under conditions that provide a peel strength to such layer of less than 300 g/in. A UV adhesive will have different degrees of bonding to these coatings; more to EAA and EMA and less to LDPE. Also EAA and EMA have the poorest bond to polypropylene, and are likely to be the most effective materials for use in the inner substrate of the labels of this invention. The LDPE would likely be more compatible with some of the common rubber based pressure sensitive adhesives of the type employed on pressure sensitive labels that include a release liner. The use of the aforementioned polymers as the inner substrate has the potential advantage that the coating is a solid polymer layer, and can easily be made thin, e.g., on the order of 0.5 mils, not only covering the tack, but serving as a more effective barrier to odor and being usable with a wider range of curable adhesives to adhere the label to a container.

It should be understood that the labels of this invention, are generally formed from a continuous plastic film substrate formed as a laminate of the outer plastic substrate and the inner substrate. This film generally is sold to converters that form the continuous film into the labels of this invention. In some cases the converter applies a pressure-sensitive adhesive to either the lower surface of the film or to the upper surface of a release liner, adheres the release liner and adhesive to the continuous film and then cuts through the film (but not the release liner) to form individual labels held on the continuous release liner for application to a container. In other instances, the film is cut into individual labels that are stacked in a magazine and employed in a continuous labeling operation by sequentially applying adhesive to the lower surface of each label in the stack and then applying the label, through the adhesive, to a container.

While the invention has been described in detail and with reference to specific examples thereof, it will be apparent to one skilled in the art that various changes and modifications can be made therein without departing from the spirit and scope thereof.

What is claimed is:

1. A clear plastic label for attachment to a product package through a tacky adhesive component, said clear plastic label including at least an outer plastic substrate and an inner substrate secured together through a weak interlayer bond, said inner substrate having a lower surface secured to the product package through said tacky adhesive and having a peel strength to said tacky adhesive greater than the peel strength of the weak interlayer bond, whereby when the outer plastic substrate is peeled from the product package it separates from the inner substrate at said weak interlayer bond and leaves said inner substrate overlying said tacky adhesive to eliminate the tacky feel of said adhesive and at least partially mask any odor of said adhesive.

2. The clear plastic label of claim 1, wherein said weak interlayer bond is provided by a clear laminating adhesive secured to a lower surface of the outer plastic substrate and an upper surface of said inner substrate.

3. The clear plastic label of claim 2, wherein said inner substrate is a clear, biaxially oriented multilayer film including a skin layer on one side having a lower surface bonded to the product package through said tacky adhesive and a core layer on said opposite side bonded to the outer plastic substrate through said laminating adhesive.

4. The clear plastic label of claim 1, wherein said weak interlayer bond is a bonded interface between a lower surface of said outer plastic substrate and an upper, contiguous surface of said inner substrate.

5. The clear plastic film of claim 4, wherein said inner substrate has an upper plastic layer providing said upper, contiguous surface having the weak interlayer bond with the lower surface of said outer plastic substrate, said inner plastic substrate having a lower layer providing a strong bond with the tacky adhesive component to adhere the plastic film to said product package.

6. The clear plastic film of claim 5, wherein said upper plastic layer and lower layer of said inner plastic substrate include different polymers.

7. The clear plastic film of claim 5, wherein said upper plastic layer of said inner substrate is a polyurethane layer providing a weak bond to the outer plastic substrate.

8. The clear plastic film of claim 6, wherein said upper plastic layer of said inner substrate is a polyurethane layer providing a weak bond to the outer plastic substrate and said lower layer of said inner substrate is an acrylic polymer.

9. The clear plastic film of claim 8, wherein said tacky adhesive includes an acrylic polymer therein, whereby the lower layer of said inner substrate provides a strong bond to said product package through said tacky adhesive.

10. The clear plastic label of claim 4, wherein said interlayer bond has a peel strength less than 600 grams/inch.

11. The clear plastic label of claim 4, wherein said interlayer bond has a peel strength less than 300 grams/inch.

12. The clear plastic label of claim 4, wherein said interlayer bond has a peel strength less than 100 grams/inch.

13. The clear plastic label of claim 4, wherein said inner plastic substrate has a thickness less than 0.15 mils.

14. The clear plastic label of claim 4, wherein said inner plastic substrate has a thickness no greater than 0.12 mils.

15. The clear plastic label of claim 4, wherein said inner plastic substrate has a thickness between about 0.1 and about 0.12 mils.

16. The clear plastic label of claim 4, wherein said outer plastic substrate has a thickness in excess of 1.5 mils.

17. The clear plastic label of claim 4, wherein said outer plastic substrate has a thickness in excess of 2.0 mils.

18. The clear plastic label of claim 4, wherein said outer plastic substrate has a thickness of about 2.2 mils.

19. The clear plastic label of claim 10, wherein said outer plastic substrate has a thickness in excess of 1.5 mils.

20. The clear plastic label of claim 11, wherein said outer plastic substrate has a thickness in excess of 1.5 mils.

21. The clear plastic label of claim 12, wherein said outer plastic substrate has a thickness in excess of 1.5 mils.

22. The clear plastic label of claim 10 wherein said outer plastic substrate has a thickness in excess of 2.0 mils.

23. The clear plastic label of claim 11, wherein said outer plastic substrate has a thickness in excess of 2.0 mils.

24. The clear plastic label of claim 12, wherein said outer plastic substrate has a thickness in excess of 2.0 mils.

25. The clear plastic label of claim 10, wherein said outer plastic substrate has a thickness of about 2.2 mils.

26. The clear plastic label of claim 11 wherein said outer plastic substrate has a thickness of about 2.2 mils.

27. The clear plastic label of claim 12, wherein said outer plastic substrate has a thickness of about 2.2 mils.

28. The clear plastic label of claim 13, wherein said outer plastic substrate has a thickness in excess of 1.5 mils.

29. The clear plastic label of claim 14, wherein said outer plastic substrate has a thickness in excess of 1.5 mils.

30. The clear plastic label of claim 15, wherein said outer plastic substrate has a thickness in excess of 1.5 mils.

31. The clear plastic label of claim 13, wherein said outer plastic substrate has a thickness in excess of 2.0 mils.

32. The clear plastic label of claim 14, wherein said outer plastic substrate has a thickness in excess of 2.0 mils.

33. The clear plastic label of claim 15, wherein said outer plastic substrate has a thickness in excess of 2.0 mils.

34. The clear plastic label of claim 13, wherein said outer plastic substrate has a thickness of about 2.2 mils.

35. The clear plastic label of claim 14, wherein said outer plastic substrate has a thickness of about 2.2 mils.

36. The clear plastic label of claim 15, wherein said outer plastic substrate has a thickness of about 2.2 mils.

37. The clear plastic label of claim 1, in combination with said product package.

38. The clear plastic label of claim 2, in combination with said product package.

39. The clear plastic label of claim 3, in combination with said product package.

40. The clear plastic label of claim 4, in combination with said product package.

41. A method for maintaining a cover over an aesthetically undesirable tacky adhesive employed to adhere a clear plastic label to a product package, said method including the steps of: forming a clear plastic label with an outer plastic substrate and an inner plastic substrate adhered together by a weak interlayer bond having a peel strength less than the peel strength of the inner plastic substrate to said tacky adhesive employed to adhere the clear plastic label to the product package and securing the clear plastic label to the product package through said tacky adhesive, whereby when a peel force is applied to said label the outer plastic substrate separates from the inner substrate of the label at said weak interlayer bond and leaves said inner substrate overlying said tacky adhesive.

42. The method of claim 41, wherein said weak interlayer bond is provided by employing a clear laminating adhesive to adhere said outer plastic substrate to said inner plastic substrate.

43. The method of claim 42, including the step of forming said inner substrate as a clear, biaxially oriented multilayer film including a skin layer on one side having a lower surface bonded to the product package through said tacky adhesive and a core layer on said opposite side bonded to the outer plastic substrate through said laminating adhesive.

44. The method of claim 41, including the step of forming said weak interlayer bond at a bonded interface between a lower surface of said outer plastic substrate and an upper, contiguous surface of said inner substrate.

45. The method of claim 44, including the step of forming said inner substrate with an upper plastic layer and a lower layer, said upper plastic layer providing said upper, contiguous surface having the weak interlayer bond with the lower surface of said outer plastic substrate, said lower layer providing a strong bond with the tacky adhesive component to adhere the plastic film to said product package.

46. The method of claim 45, including the step of forming said upper plastic layer and said lower layer of said inner plastic substrate from different polymers.

47. The clear plastic label of claim 1, wherein said outer plastic substrate includes printed indicia thereon.

48. The clear plastic label of claim 47, wherein said printed indicia is a coupon.

49. The clear plastic label of claim 47, wherein said printed indicia thereon renders said outer plastic substrate a collectable item.
